(19) United States
(12) Patent Application Publication
(10) Pub. No.: US 2022/0089269 A1
(43) Pub. Date: Mar. 24, 2022

(54) Large-Scale Semi-Rigid Structure Airship

(71) Applicants: Shanghai Jiao Tong University, Shanghai (CN); New United Group Co., Ltd., Changzhou City (CN)

(72) Inventors: Wujun Chen, Shanghai (CN); Gongyi Fu, Changzhou City (CN); Xiaoliang Wang, Changzhou City (CN); Yanguang Wang, Changzhou City (CN); Weizhi Wang, Changzhou City (CN); Jiandong Xu, Changzhou City (CN); Lingchen Tang, Changzhou City (CN); Jun Yang, Changzhou City (CN)

(21) Appl. No.: 17/496,019

(22) Filed: Oct. 7, 2021

Related U.S. Application Data
(63) Continuation-in-part of application No. PCT/CN2019/087978, filed on May 22, 2019.

(30) Foreign Application Priority Data
Apr. 8, 2019 (CN) 201910275705.7

(51) Int. Cl. B64B 1/08; B64B 1/20; B64B 1/58

(52) U.S. Cl. CPC B64B 1/08; B64B 1/30; B64B 1/58; B64B 1/20

(57) ABSTRACT

The present invention discloses a large-scale semi-rigid structure airship, relating to the technical field of aerostats, which comprises a ship body, vector side thrusters, a vector tail thruster, an X-shaped inflatable tail fin, air cushions, and a pod, wherein the ship body comprises a pretensioned capsule and a tensegrity keel; the pretensioned capsule is sleeved onto an outer surface of the tensegrity keel in a pretensioning mode; the vector side thrusters are provided at lower-side portions of the ship body; the vector tail thruster is provided at the tail of the ship body; the X-shaped inflatable tail fin is arranged at the tail of the ship body in an X shape; the air cushions are provided at lower portions of the ship body; and the pod is provided at a lower portion of the ship body. The airship of the present invention uses a structure of integrated and synergistic force bearing by an integral keel of a tension-compression self-balancing system and the pretensioned capsule, and has characteristics of integral conformity of the capsule under a zero pressure, an integral rigidity under a low pressure, high load bearing, a flexible load arrangement, and high-efficiency transfer.

### CROSS-REFERENCE TO RELATED APPLICATIONS

The present application is a continuation-in-part application of PCT Application No. PCT/CN2019/087978, filed May 22, 2019, which claims priority to Chinese Application No. 201910275705.7, filed Apr. 8, 2019, both of which are incorporated herein by reference in their entirety.

### FIELD OF THE INVENTION

The present invention relates to the technical field of aerostats, and in particular to a large-scale semi-rigid structure airship.

### DESCRIPTION OF THE PRIOR ART

Aerostats are aircrafts with power control and maneuverability, which use the principle of Lighter-Than-Air (LTA). Aerostats had a glorious history, but were later replaced by jet aircrafts. With the development of new materials, power, energy, computers and other technologies, the special working principles and flight characteristics of airships have received attention and development in some specific application fields.

Airship structures are generally divided into soft type, rigid type, and semi-rigid type. Due to different structural systems, airships present different structural characteristics and flight features, and have different applications. The soft type airship has a light weight, a low rigidity, and a low uneven-load bearing capacity. The rigid type airship has a heavy weight, a high rigidity, and a large load bearing capacity, but requires a large scale, a high cost, and a difficult control. The semi-rigid type airship combines advantages of the two, which is an innovative and active form of a new airship structure, and a suitable structural system is constructed according to a specific application requirement.

Steve Smith, et al., “HiSentinel 80: Flight of a High Altitude Airship” (11th AIAA ATIO, 20-22 Sep. 2011, Virginia Beach, Va., AIAA 2011-6973) introduces a typical system of stratospheric airships, i.e., HiSentinel airships, which adopts a fully flexible structure system, but due to the unsaturated shape, the aerodynamic characteristics are complicated and the trajectory is difficult to predict and control.

Stavros P. Androulakakis et al., “Status and Plans of High Altitude Airship (HAA™) Program” (AIAA Lighter-Than-Air Systems Technology (LTA) Conference, 25-28 Mar. 2013, Daytona Beach, Fla., AIAA 2013-1362), introduce another typical system of stratospheric airships, which adopts a stable shape and realizes airship lift-off by buoyancy control, and introduces an airship proving scheme and a flight test. However, the proving flight does not realize stratospheric flight, and the difficulty lies in that a huge amount of air needs to be sucked and discharged for lift-off and conformal return, so as to realize net buoyancy balance, so a large number of equipment needs to be equipped, which leads to a sharp increase in energy resources, thus increasing the system weight and control complexity.

Chen Wujun et al., in Chinese Patent Application No. 201210162876.7 entitled “Aerostat with a Variable Configuration”, propose an aerostat with a variable configuration, which actively controls shape change during lift-off and return processes, thus realizing control of large shape change. However, it is difficult to implement control of the aerostat with the variable configuration, and a force bearing and safety design for a capsule structure with a non-determined shape is difficult.

Fu Gongyi et al., in Chinese Patent Application No. 201521080600.X entitled “Rigid Structure System of Big Size Airship”, propose an airship of a rigid structure system, comprising a prestressed structure system and a flexible external capsule structure, wherein the prestressed structure system consists of a central mandrel, prestressed stiffening rings and longitudinal tie rods. However, stiffening ring tubes of this structure have low rigidities and poor stabilities. The long central mandrel sequentially passes through the stiffening rings from head to end, which causes the central mandrel to be subjected to a greater bending force, easy to lose stability, low in bearing capacity, inconvenient to install and difficult to form an overall feasible pretension; and it is difficult for the capsule and the structural system to bear a force synergistically, so that the overall structure efficiency is low.

Wang Fei and Wang Weizhi, in an article entitled “Structure Design and Finite Element Analysis of Semi-rigid Stratospheric Airship Keel” (Spacecraft Recovery & Remote Sensing, 2011, 32 (4): 14-23.), propose a semi-rigid system. In the airship structure system, the rigid structure is not a self-supporting system and must be combined with a capsule, so the integrity is poor, and it is difficult for rigid and flexible structures to work synergistically; the rigidity and bearing capacity of a ring frame are low; and a main girder is greatly compressed and bent, the constraint of the ring frame is weak, the force bearing is complex, the force transmission is unclear, and its stability and bearing capacity are low.

Therefore, those skilled in the art are committed to developing a large-scale semi-rigid structure airship, which has the following advantages: low aerodynamic damping, a modular and standardized design, easy to manufacture and integrate, and a low cost; integral conformity of a capsule under a zero pressure, an integral rigidity and high load bearing under a low pressure, a flexible load arrangement, high-efficiency transfer, and a low difficulty for overall control.

### SUMMARY OF THE INVENTION

In view of the above-mentioned shortcomings of the prior art, the technical problem to be solved by the present invention is to provide an airship, which has low aerodynamic damping, a reasonable load distribution, a high transfer efficiency, good integral conformity under a zero pressure, an integral rigidity and high load bearing under a low pressure, easy manufacturing and integration, and low manufacturing, use and maintenance costs.

To achieve the above-mentioned purpose, the present invention provides a large-scale semi-rigid structure airship, which comprises a ship body, vector side thrusters, a vector tail thruster, an X-shaped inflatable tail fin, air cushions, and a pod, wherein the ship body comprises a pretensioned capsule and a tensegrity keel; the pretensioned capsule is sleeved onto an outer surface of the tensegrity keel in a pretensioning mode; the vector side thrusters are provided at lower-side portions of the ship body; the vector tail thruster is provided at the tail of the ship body; the X-shaped inflatable tail fin is arranged at the tail of the ship body in an X shape; the air cushions are provided at lower portions of the ship body; and the pod is provided at a lower portion of the ship body.

Further, the tensegrity keel comprises stiffening rings, longitudinal tie rods and shuttle-shaped truss mandrels, wherein the stiffening ring is in a shape of a hub and comprises a circumferential triangular truss, radial tie rods, and a spindle-shaped and thin-walled tube shaft bossing; the circumferential triangular truss is provided on an outer circumference of the stiffening ring, and has a complete circular structure; the spindle-shaped and thin-walled tube shaft bossing is provided at the center of the stiffening ring; the central axis of the spindle-shaped and thin-walled tube shaft bossing, the central axis of the stiffening ring and the central axis of the tensegrity keel coincide; the radial tie rods connect an inner ring of the circumferential triangular truss and the spindle-shaped and thin-walled tube shaft bossing; the radial tie rods are evenly arranged in the circumferential direction of the stiffening ring; the radial tie rods are arranged symmetrically in two layers along the central plane of the stiffening ring; the circumferential triangular truss, the radial tie rods and the spindle-shaped and thin-walled tube shaft bossing form a self-balancing force system; the shuttle-shaped truss mandrels are provided along the central axis of the tensegrity keel; the longitudinal tie rods are provided on an outer ring of the circumferential triangular truss; and the stiffening ring, the longitudinal tie rods and the shuttle-shaped truss mandrel constitute a tension-compression self-balancing system.

Further, the tensegrity keel comprises a plurality of the stiffening rings, and the stiffening rings are provided in parallel; the stiffening rings provided in the middle of the tensegrity keel are equidistantly arranged along the central axis of the tensegrity keel, and the diameters of the stiffening rings provided in the middle of the tensegrity keel are equal and larger than the diameters of the stiffening rings provided at head and tail ends of the tensegrity keel; and the number of the stiffening rings provided in the middle of the tensegrity keel is greater than or equal to 5 and less than or equal to 8.

Further, the tensegrity keel comprises multiple sections of the shuttle-shaped truss mandrels, and the shuttle-shaped truss mandrels are sequentially connected to a nose cone at the ship head of the ship body, the spindle-shaped and thin-walled tube shaft bossings of the various stiffening rings, and a stern cone at the ship tail of the ship body, thus forming a mandrel from the ship head to the ship tail of the ship body.

Further, the longitudinal tie rods are sequentially connected to the nose cone at the ship head of the ship body, the circumferential triangular trusses of the various stiffening rings, and the stern cone at the ship tail of the ship body; and the longitudinal tie rods are evenly provided in the circumferential directions of the circumferential triangular trusses, and the longitudinal tie rods correspond to the radial tie rods one by one.

Further, the pretensioned capsule is a combined geometric body, the head of the pretensioned capsule is hemispherical, the middle portion of the pretensioned capsule is cylindrical, and the tail of the pretensioned capsule is conical.

Further, the air cushions have double-layer and multi-air chamber structures, the supporting structures of the air cushions are connected to lower portions of the circumferential triangular trusses, two or three groups of air cushions are evenly provided in the fore and aft direction of the ship body, and each group of the air cushions are arranged symmetrically in the left and right directions of the ship body.

Further, the supporting structure of the X-shaped inflatable tail fin is connected to the circumferential triangular truss; and the vector tail thruster realizes omnidirectional vector rotation, and the supporting structure of the vector tail thruster is connected to the shuttle-shaped truss mandrel.

Further, the vector side thrusters realize pitch vector rotation, and the number of the vector side thrusters is 4, which are respectively provided at ±120° of the stiffening rings at the head and tail of the ship body; and the pod has a distributed structure, and the supporting structure of the pod is connected to two or three stiffening rings in a hanging manner.

Further, the large-scale semi-rigid structure airship further comprises a solar cell array, cells of the solar cell array are semi-flexible monocrystalline cells, and the solar cell array is modularly embedded and connected to an upper portion of the pretensioned capsule.

Compared with the prior art, the present invention has obvious technical effects as follows:

1. The large-scale semi-rigid structure airship of the present invention adopts a modular and standardized design, is easy to manufacture and integrate, and has a low cost.
2. The large-scale semi-rigid structure airship of the present invention has an aerodynamic shape with low aerodynamic damping, and the pretensioned capsule has integral conformity under a zero pressure, an integral rigidity and high load bearing under a low pressure.
3. The large-scale semi-rigid structure airship of the present invention has a flexible load arrangement and high-efficiency transfer, and the difficulty for overall control is low.

The concept, specific structure and resulting technical effect of the present invention are further described below in conjunction with the drawings to fully understand the object, features, and effects of the present invention.

### BRIEF DESCRIPTION OF THE DRAWINGS

FIG. 1 is a three-dimensional perspective view of a preferred embodiment of the present invention;

FIG. 2 is a three-dimensional view of a preferred embodiment of the present invention;

FIG. 3 is a three-dimensional view of a tensegrity keel of a preferred embodiment of the present invention; and

FIG. 4 is a three-dimensional view of a stiffening ring of a preferred embodiment of the present invention.

In the figures: 1—pretensioned capsule; 2—tensegrity keel; 3—vector side thruster; 4—vector tail thruster; 5—X-shaped inflatable tail fin; 6—air cushion; 7—pod; 8—solar cell array; 201—stiffening ring, 202—longitudinal tie rod, 203—shuttle-shaped truss mandrel, 204—nose cone at ship head, 205—stern cone at ship tail; 20101—circumferential triangular truss, 20102—radial tie rod, 20103—spindle-shaped and thin-walled tube shaft bossing; 2010101—outer ring of circumferential triangular truss; 2010102—inner ring of circumferential triangular truss.

### DETAILED DESCRIPTION OF THE PREFERRED EMBODIMENTS

Preferred embodiments of the present invention are described below with reference to the drawings of the description to make the technical contents clearer and easier to understand. The present invention can be embodied in various forms of embodiments, and the scope of protection of the present invention is not limited to the embodiments mentioned herein.

In the drawings, the same numeral indicates components having the same structure, and similar numerals indicate assemblies having similar structures or functions throughout. The size and thickness of each assembly shown in the drawings are shown arbitrarily, and the size and thickness of each assembly are not limited in the present application. In order to make the illustration clearer, the thickness of the component in some places of the drawings is appropriately exaggerated.

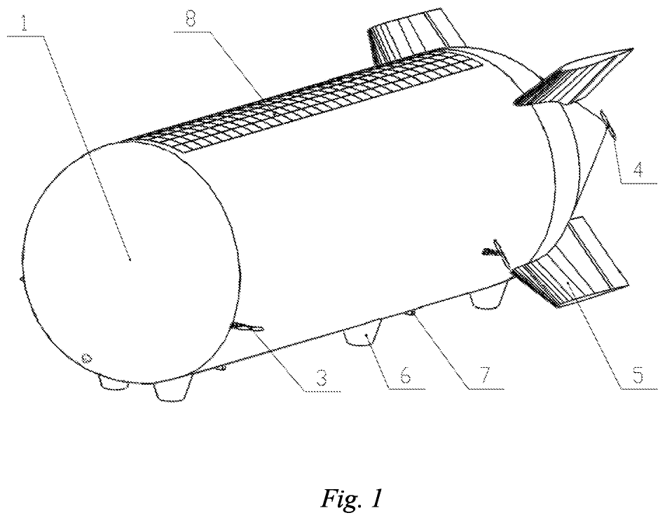

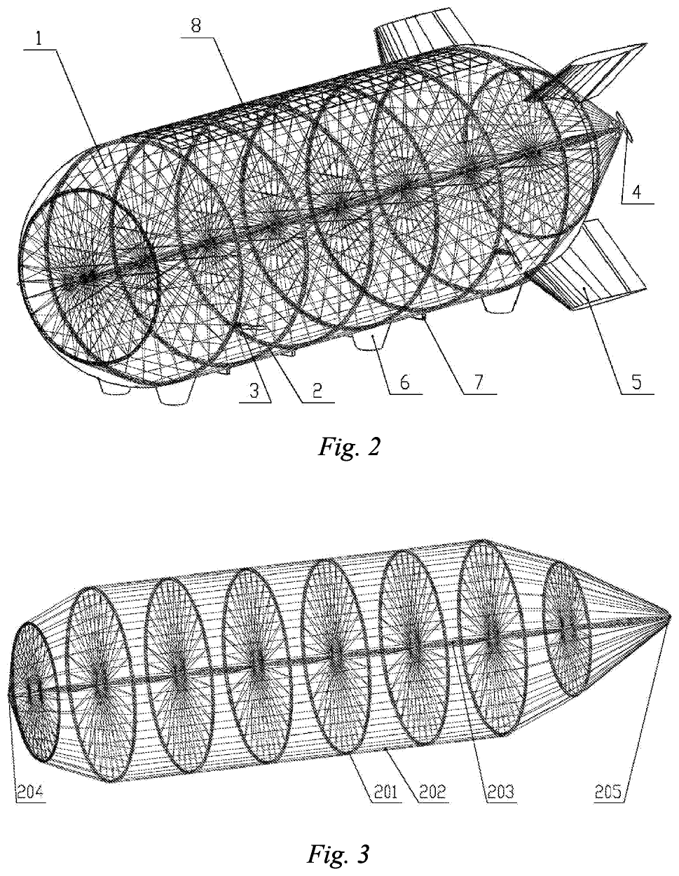

As shown in FIGS. 1 and 2, this embodiment discloses a large-scale semi-rigid structure airship, comprising a ship body, vector side thrusters 3, a vector tail thruster 4, an X-shaped inflatable tail fin 5, air cushions 6, a pod 7, a solar cell array 8, wherein the ship body comprises a pretensioned capsule 1 and a tensegrity keel 2, and the pretensioned capsule 1 is sleeved onto an outer surface of the tensegrity keel 2 in a pretensioning mode.

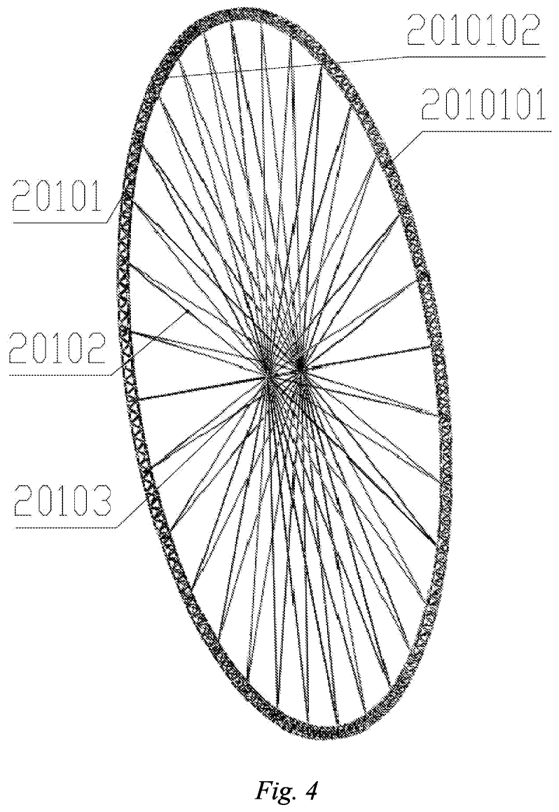

As shown in FIG. 3, the tensegrity keel 2 comprises stiffening rings 201, longitudinal tie rods 202, and shuttle-shaped truss mandrels 203. The stiffening ring 201 is in a shape of a hub. The stiffening ring 201 comprises a circumferential triangular truss 20101, radial tie rods 20102, and a spindle-shaped and thin-walled tube shaft bossing 20103. The circumferential triangular truss 20101 is provided on an outer circumference of the stiffening ring 201, and the circumferential triangular truss 20101 has a complete circular structure. The spindle-shaped and thin-walled tube shaft bossing 20103 is provided at the center of the circumferential triangular truss 20101, and the central axis of the spindle-shaped and thin-walled tube shaft bossing 20103, the central axis of the stiffening ring 201 and the central axis of the tensegrity keel 2 coincide. The radial tie rods 20102 connect an inner ring 2010102 of the circumferential triangular truss and the spindle-shaped and thin-walled tube shaft bossing 20103. The radial tie rods 20102 are evenly arranged in the circumferential direction of the stiffening ring 201. The radial tie rods 20102 are arranged symmetrically in two layers along the central plane of the stiffening ring 201. The circumferential triangular truss 20101, the radial tie rods 20102 and the spindle-shaped and thin-walled tube shaft bossing 20103 form a self-balancing force system. The shuttle-shaped truss mandrels 203 are provided along the central axis of the tensegrity keel 2. The longitudinal tie rods 202 are provided on an outer ring 2010101 of the circumferential triangular truss. The stiffening ring 201, the longitudinal tie rods 202 and the shuttle-shaped truss mandrel 203 constitute a tension-compression self-balancing system.

As shown in FIG. 3, the tensegrity keel 2 comprises a plurality of stiffening rings 201, and the various stiffening rings 201 are provided in parallel. The stiffening rings 201 provided in the middle of the tensegrity keel 2 are equidistantly arranged along the central axis of the tensegrity keel 2, and the diameters of the stiffening rings 201 provided in the middle of the tensegrity keel 2 are equal and larger than the diameters of the stiffening rings 201 provided at head and tail ends of the tensegrity keel 2. The number of the stiffening rings 201 provided in the middle of the tensegrity keel 2 is greater than or equal to 5 and less than or equal to 8, and the number of the stiffening rings 201 in the middle of the tensegrity keel 2 is preferably 6 in this embodiment.

The tensegrity keel 2 comprises multiple sections of shuttle-shaped truss mandrels 203, and the various sections of the shuttle-shaped truss mandrels 203 are sequentially connected to a nose cone 204 at the ship head of the ship body, the spindle-shaped and thin-walled tube shaft bossings 20103 of the various stiffening rings 201, and a stern cone 205 at the ship tail of the ship body, thus forming a mandrel from the ship head to the ship tail of the ship body.

The longitudinal tie rods 202 are sequentially connected to the nose cone at the ship head of the ship body, the circumferential triangular trusses 20101 of the various stiffening rings 201, and the stern cone at the ship tail of the ship body. The longitudinal tie rods 202 are evenly provided in the circumferential directions of the circumferential triangular trusses 20101, and the longitudinal tie rods 202 correspond to the radial tie rods 20102 one by one.

As shown in FIG. 1, the pretensioned capsule 1 is a combined geometric body, the head of the pretensioned capsule 1 is hemispherical, the middle portion of the pretensioned capsule 1 is cylindrical, and the tail of the pretensioned capsule 1 is conical.

The vector side thrusters 3 are provided at lower-side portions of the ship body; the vector tail thruster 4 is provided at the tail of the ship body; the X-shaped inflatable tail fin 5 is arranged at the tail of the ship body in an X shape; the air cushions 6 are provided at lower portions of the ship body; and the pod 7 is provided at a lower portion of the ship body.

The vector side thrusters 3 realize pitch vector rotation, and the number of the vector side thrusters 3 is 4, which are respectively provided at ±120° of the stiffening rings 201 at the head and tail of the ship body. The vector tail thruster 4 realizes omnidirectional vector rotation, and the supporting structure of the vector tail thruster 4 is connected to the shuttle-shaped truss mandrel 203. The supporting structure of the X-shaped inflatable tail fin 5 is connected to the circumferential triangular truss 20101, and the X-shaped inflatable tail fin 5 is an inflatable tail fin without a rudder control surface.

The air cushions 6 have double-layer and multi-air chamber structures. The supporting structures of the air cushions 6 are connected to lower portions of the circumferential triangular trusses 20101. Two or three groups of air cushions 6 are evenly provided in the fore and aft direction of the ship body. In this embodiment, there are preferably three groups of air cushions. Each group of the air cushions 6 are arranged symmetrically in the left and right directions of the ship body.

The pod 7 has a distributed structure, and the supporting structure of the pod 7 is connected to two stiffening rings in a hanging manner.

Cells of the solar cell array 8 are semi-flexible monocrystalline cells, and the solar cell array 8 is modularly embedded and connected to an upper portion of the pretensioned capsule 1.

In this embodiment, the pretensioned capsule 1 can be made of a composite fabric film with a high specific strength and a multi-functional layer, the tensegrity keel 2 can be made of CFRP thin-walled tubes and tie rods, and specific parameters of various members of the tensegrity keel 2 can be determined according to mechanical parameters of the structure.

The large-scale semi-rigid structure airship disclosed in the present invention has low aerodynamic damping, and each functional module adopts a modular and standardized design, which is easy to manufacture and integrate, and has a low cost. The pretensioned capsule 1 adopts a strain compensation design, which is integrated with the tensegrity keel 2 through pretensioning, so as to realize synergistic force bearing by the tensegrity keel 2 and the pretensioned capsule 1, which has characteristics of integral conformity of the capsule under a zero pressure, an integral rigidity and high load bearing under a low pressure, and has advantages of a flexible load arrangement, high-efficiency transfer, and a low difficulty for overall control.

The preferred and specific embodiments of the present invention have been described in detail above. It should be understood that a person of ordinary skill in the art would be able to make various modifications and variations according to the concept of the present invention without involving any inventive effort. Therefore, any technical solution that can be obtained by a person skilled in the art by means of logical analysis, reasoning or limited trials on the basis of the prior art and according to the concept of the present invention should fall within the scope of protection defined by the claims.

1. A large-scale semi-rigid structure airship, comprising a ship body, vector side thrusters, a vector tail thruster, an X-shaped inflatable tail fin, air cushions, and a pod, wherein the ship body comprises a pretensioned capsule and a tensegrity keel; the pretensioned capsule is sleeved onto an outer surface of the tensegrity keel in a pretensioning mode; the vector side thrusters are provided at lower-side portions of the ship body; the vector tail thruster is provided at the tail of the ship body; the X-shaped inflatable tail fin is arranged at the tail of the ship body in an X shape; the air cushions are provided at lower portions of the ship body; and the pod is provided at a lower portion of the ship body.

2. The large-scale semi-rigid structure airship of claim 1, characterized in that the tensegrity keel comprises stiffening rings, longitudinal tie rods and shuttle-shaped truss mandrels, wherein the stiffening ring is in a shape of a hub and comprises a circumferential triangular truss, radial tie rods, and a spindle-shaped and thin-walled tube shaft bossing; the circumferential triangular truss is provided on an outer circumference of the stiffening ring, and has a complete circular structure; the spindle-shaped and thin-walled tube shaft bossing is provided at the center of the stiffening ring; the central axis of the spindle-shaped and thin-walled tube shaft bossing, the central axis of the stiffening ring and the central axis of the tensegrity keel coincide; the radial tie rods connect an inner ring of the circumferential triangular truss and the spindle-shaped and thin-walled tube shaft bossing; the radial tie rods are evenly arranged in the circumferential direction of the stiffening ring; the radial tie rods are arranged symmetrically in two layers along the central plane of the stiffening ring; the circumferential triangular truss, the radial tie rods and the spindle-shaped and thin-walled tube shaft bossing form a self-balancing force system; the shuttle-shaped truss mandrels are provided along the central axis of the tensegrity keel; the longitudinal tie rods are provided on an outer ring of the circumferential triangular truss; and the stiffening ring, the longitudinal tie rods and the shuttle-shaped truss mandrel constitute a tension-compression self-balancing system.

3. The large-scale semi-rigid structure airship of claim 2, characterized in that the tensegrity keel comprises a plurality of the stiffening rings, and the stiffening rings are provided in parallel; the stiffening rings provided in the middle of the tensegrity keel are equidistantly arranged along the central axis of the tensegrity keel, and the diameters of the stiffening rings provided in the middle of the tensegrity keel are equal and larger than the diameters of the stiffening rings provided at head and tail ends of the tensegrity keel; and the number of the stiffening rings provided in the middle of the tensegrity keel is greater than or equal to 5 and less than or equal to 8.

4. The large-scale semi-rigid structure airship of claim 3, characterized in that the tensegrity keel comprises multiple sections of the shuttle-shaped truss mandrels, and the shuttle-shaped truss mandrels are sequentially connected to a nose cone at the ship head of the ship body, the spindle-shaped and thin-walled tube shaft bossings of the various stiffening rings, and a stern cone at the ship tail of the ship body, thus forming a mandrel from the ship head to the ship tail of the ship body.

5. The large-scale semi-rigid structure airship of claim 4, characterized in that the longitudinal tie rods are sequentially connected to the nose cone at the ship head of the ship body, the circumferential triangular trusses of the various stiffening rings, and the stern cone at the ship tail of the ship body; and the longitudinal tie rods are evenly provided in the circumferential directions of the circumferential triangular trusses, and the longitudinal tie rods correspond to the radial tie rods one by one.

6. The large-scale semi-rigid structure airship of claim 5, characterized in that the pretensioned capsule is a combined geometric body, the head of the pretensioned capsule is hemispherical, the middle portion of the pretensioned capsule is cylindrical, and the tail of the pretensioned capsule is conical.

7. The large-scale semi-rigid structure airship of claim 6, characterized in that the air cushions have double-layer and multi-air chamber structures, the supporting structures of the air cushions are connected to lower portions of the circumferential triangular trusses, two or three groups of air cushions are evenly provided in the fore and aft direction of the ship body, and each group of the air cushions are arranged symmetrically in the left and right directions of the ship body.

8. The large-scale semi-rigid structure airship of claim 7, characterized in that the supporting structure of the X-shaped inflatable tail fin is connected to the circumferential triangular truss; and the vector tail thruster realizes omnidirectional vector rotation, and the supporting structure of the vector tail thruster is connected to the shuttle-shaped truss mandrel.

9. The large-scale semi-rigid structure airship of claim 8, characterized in that the vector side thrusters realize pitch vector rotation, and the number of the vector side thrusters is 4, which are respectively provided at ±120° of the stiffening rings at the head and tail of the ship body; and the pod has a distributed structure, and the supporting structure of the pod is connected to two or three stiffening rings in a hanging manner.

10. The large-scale semi-rigid structure airship of claim 9, characterized by further comprising a solar cell array, cells of the solar cell array are semi-flexible monocrystalline cells, and the solar cell array is modularly embedded and connected to an upper portion of the pretensioned capsule.
